(19) United States
(12) Patent Application Publication
(10) Pub. No.: US 2014/0326356 A1
(43) Pub. Date: Nov. 6, 2014

(54) COMPOSITE HOSE HAVING A HIGH THERMAL INSULATION FOR LIQUID GAS TRANSFER

(71) Applicant: Mateo Group S.r.l., (US)

(72) Inventor: Mario Orfei, Peschierra Borromeo (IT)

(73) Assignee: Mateo Group S.r.l., Peschiera Borromeo (IT)

(21) Appl. No.: 13/874,723

(22) Filed: May 1, 2013

(51) Int. Cl. F16L 59/153; F16L 11/12

(52) U.S. Cl. CPC F16L 59/153; F16L 11/12
USPC 138/137

(57) ABSTRACT

A composite hose for liquid gas transfer covered by a material having a high thermal insulation. The hose is preferably Compotec® Cryotec 660 and has the properties of being resistant to corrosion and salt of the sea, to UV radiation, to ozone and to sea water. The hose is covered by an insulation layer, which includes one or more layers of an insulating mattress made of a silicon dioxide gel, preferably Cryogel™ Z. The resulting device has an integrated wall to vapor, in order to give the best thermal protection with the lowest weight and thickness, with completely no passage of water vapor. It is very flexible and light in order to provide an efficient thermal insulation during the process of liquid gas transfer, in particular avoiding the creation of ice on the outside of the hose.

FIELD OF INVENTION

The present invention is related to a new kind of composite hose, particularly usable in order to transfer liquid gas. Specifically, the hoses of the present invention consist of flexible composite hoses, preferably Compotec® Cryotec 660, used with one or more layers of insulating mattress made of a silicon dioxide gel (aerogel), preferably Cryogel™ Z, in order to provide an efficient thermal insulation during the process of liquid gas transfer.

### BACKGROUND OF THE INVENTION

More in detail, the basic problem leading to the invention is a typical problem occurring during the transfer of natural gas inside flexible hoses. In particular, when said gas is transported by sea on LNG carriers (LNG=Liquefied Natural Gas), it is first liquefied at the starting docks so that it occupies a smaller volume and can be easily transported in safe conditions (because in the liquid state it is not inflammable) in order to reach the countries of final destination where it is used.

The problem arises from this liquefaction process, when the gas is cooled down at a temperature of approximately −162° C., and the outer side of the transfer hose is covered by a layer of ice. The ice reaches a significant thickness so that it increases the weight of the same hose, leading to a risk of damage in the structure and/or to risk of injuries for persons that come in contact with the ice.

At the present state-of-the-art, some solutions are known which propose to cover the gas transportation hoses, in order to decrease the effects of the above said problem. These solutions include:
rope lagging: the outer side of the flexible hose is covered by a rope made of polypropylene, said rope having diameters between 20-25 mm; this rope is rolled up all around the outer side of the hose and all along its longitudinal axis, and fixed at its respective extreme ends; this method protects the outer side of the hose, decreases the risk of injuries, but makes the structure of the hose very rigid and heavy, and, therefore, it cancels any advantage of using a composite hose instead of an ordinary rubber hose;
covering by a glass wool: the glass wool is achieved by fusion, at a specific temperature between 1.300-1.500° C., of a mixture of sand and glass that is followed by a process of conversion in fibers, with the addition of a binder that increases the cohesion of the same obtained fibers; then, the fibers are warmed up at approximately 200° C. and submitted to a calendering process in order to give more mechanical strength and solidity; finally, the glass wool is submitted to a high pressure process and cut in order to achieve coils or panels;
covering by a mineral wool: the mineral wool was discovered at the beginning of twentieth century on the Hawaii islands; it is achieved by a solidification process, in the form of fibers, of the melted lava, expelled out in the air during the eruption activities; therefore, it is a natural product that combines the strength of the rock with the thermal insulation typical of the wool, besides being a strictly natural material and providing a high thermal insulation, it is also a good absorber of acoustic waves, as a consequence of its structure being composed of open cells.

Usually, the above materials, glass wool and mineral wool, are safe when they are contained inside proper cavity walls. However, in case of breaks of these cavity walls, it is possible that these materials are lost in the environment as very tiny particles of micro-fibers of glass and micro-fibers of minerals that are aluminates and silicates. These particles, when they are very thin, belong to the class of PM 10, PM 20, PM 2.5 (the numeric value being the maximum size of particles measured in micro-meters). The inhalation of these substances can cause irritation of the air ways, disruption of the eyesight in case of contact with eyes, abrasion and irritation of skin. In fact, although fibers of glass wool and fibers of mineral wool have been assigned to group 3 by the IARC (International Agency for Research on Cancer) and, therefore, they do not lead to a risk for cancer, they surely can cause irritation of the skin with a level of risk in the class R38.

### BRIEF SUMMARY OF THE INVENTION

The present invention will overcome and solve all the above problems, its main goal consisting in the development of a composite hose for liquid gas transfer, with liquid gas having a very low temperature, and said hose being covered by a material having a high thermal insulation, like, for example, one or more layers of insulating mattress made of a silicon dioxide gel.

Another goal consists in avoiding the creation of ice on the outer side of said hose, in order to avoid any possible mechanical breakdown.

A further goal is achieving a higher level of safety for the operators, because avoiding the creation of ice on the outer side of the hose leads to avoiding the risk of injuries due to the contact of persons with ice.

Another goal is to keep the flexibility of a hose, in order to make it possible for its transportation to the place of its final installation, and in order to achieve some degree of freedom in view of possible motion of ships during the transfer operations in docks.

Another further goal is to achieve an easy installation of said hose covering, decreasing the use of specialized workers required for its installation.

Therefore, the specific subject of the present invention is a composite hose for liquid gas transfer, covered by a material having a high thermal insulation, characterized by comprising:

a flexible composite hose for liquid gas transfer, preferably Compotec® Cryotec 660, having the property of being resistant to corrosion and salt of the sea, to UV radiation, to ozone and to sea water, said hose being covered by an insulation layer;

one or more layers of insulating mattress made of a silicon dioxide gel, preferably Cryogel™ Z, achieving an integrated wall to vapor, in order to give the best thermal protection with the lowest weight and thickness, with completely no passage of water vapor, to be applied to said composite hose,

so that a compact hose can be obtained, being very flexible and light, in order to provide an efficient thermal insulation during the process of liquid gas transfer, in particular avoiding the creation of ice on the outer side of the same composite tube.

### BRIEF DESCRIPTION OF THE SEVERAL VIEWS OF THE DRAWING

This invention is now being described for illustrative but not limitative purposes, with particular reference to figures of the enclosed drawings, wherein the steps of the sequence are illustrated, with reference to the installation of the mattress of silicon dioxide gel on a flexible composite hose, with a successive installation of a rope as a string of nylon. In particular:

FIG. 1 is a perspective view of an insulating mattress, rolled up on a coil and ready to be installed on a composite hose, said mattress being made of a silicon dioxide gel;

FIG. 2 is a view in detail of said flexible composite hose, with said mattress made of a silicon dioxide gel, rolled up on it;

FIG. 3 is a view of an additional covering of said flexible composite hose, said covering being represented by a specific insulating rope, made as a string of nylon, said rope being rolled up on said composite hose;

FIG. 4 is a view of a compact hose, resulting from the application of said mattress made of silicon dioxide gel on said composite hose and the successive application of said insulating rope, made as a string of nylon; the final compact hose is arranged as a spiral and housed inside a container in order to be transported to the final place of installation.

### DETAILED DESCRIPTION

It is here underlined that only few of the many conceivable embodiments of the present invention are described, which are just some specific non-limiting examples, having the possibility to describe many other embodiments based on the disclosed technical solutions of the present invention. The different figures show the same elements using the same reference numbers.

The main problem in handling natural gas arises from its transfer operations that require some specific composite hoses, which need to be flexible, in order to adapt to changing positions that are consequent to motion of transportation ships occurring during the transfer operations at the docks.

Usually, it is possible to install gas pipelines on-shore, having length up to thousands of kilometers, but when the extraction sites are too far from the consumer sites, or they are separated from deep and extended seas, this solution is not possible, therefore it is preferred to do the transportation off-shore by ship as liquefied natural gas (LNG).

This choice requires a double conversion of state: first, the natural gas should be liquefied in an industrial plant located close to the departure docks, and then the liquid gas should be gasified again in an industrial plant located close to the arrival docks, in order to be pushed inside a network of gas pipelines that are available on-shore.

The liquefaction process is consequent to the fast cooling down of the natural gas. Nowadays, the most common process consists of a sequence of three cooling steps, involving freezing cycles by compression and using hydrocarbons as working fluids, in order to achieve very low temperatures.

The first step, using propane, achieves a temperature close to −36° C., and the second step, using ethylene achieves a temperature of −100° C.; the third step, achieving the liquefaction point of methane, close to −162° C., uses the same methane as working fluid.

In the first two steps the water vapor and the light hydrocarbons, together with some residual substances, are separated from the natural gas (the quantity of separated substances depends on the deposit in the extraction site). Therefore, the result is a liquid gas that is nearly a pure methane gas.

In the liquefaction process the volume of gas decreases up to a fraction of one part on six hundred, and it is exactly in the liquefaction process, when extremely low temperatures are achieved, that the creation of ice happens on the outer side of the flexible hoses used for gas transfer.

This phenomenon is particularly visible in tropical countries where the level of humidity in the air is very high. Therefore, the hoses increase their weight and a higher risk of damage is possible, due to this additional weight. Furthermore, the iced hoses are very dangerous because human operators could come in contact with them and could be injured by the ice.

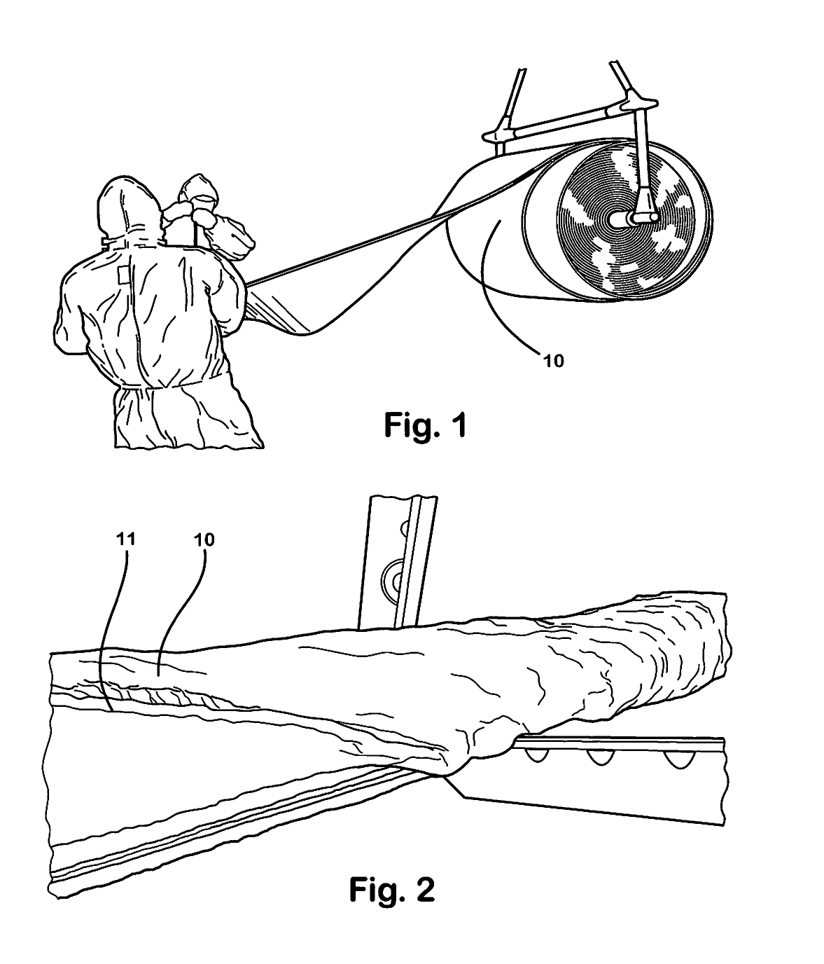

In order to avoid this problem, the present invention protects the hoses by using an insulating mattress made of a silicon dioxide gel, preferably Cryogel™ Z. In FIG. 1, it is illustrated an example of a layer of insulation mattress 10, rolled up on a coil that is pulled out and used to cover the outer surface of composite hoses 11. The Cryogel™ Z is an insulating material achieving an integrated wall to vapor, in order to give the best thermal protection with the lowest weight and thickness (available with thickness of 5 mm and 10 mm), with completely no passage of water vapor. Furthermore, the small thickness makes this material easy to be handled, so that it does not require specialized workers for the installation, and it achieves a saving of space and a saving of money. Its specific composition and flexibility make a final product that is strong and resistant to mechanical stress. Then, the insulating mattress made of silicon dioxide gel 10 contributes to maintaining the flexibility of the composite hose 11, which is a fundamental requirement in hoses used for transfer of liquefied gas, because they should be able to adapt to variations in the positions of ships during the operations of gas transfer at the docks; furthermore, when the composite hoses keep their flexibility, it is possible to provide their quick and easy transportation to the site of the next installation.

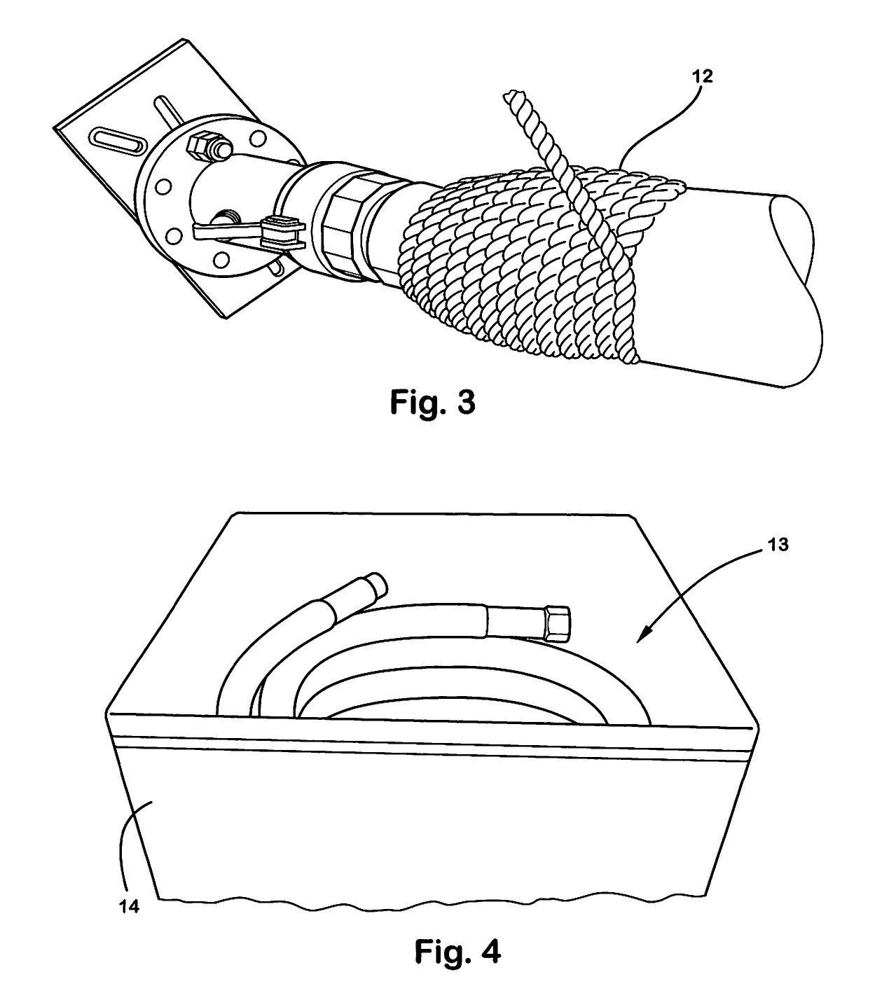

With reference to FIG. 2, said insulating mattress made of silicon dioxide gel 10 is rolled up, all along the longitudinal length, to a composite hose 11, preferably a Compotec® Cryotec 660. This specific type of hose is characterized by a particular multi-layered structure that achieves the best level of insulation, especially when compared to flexible metallic hoses. Furthermore, they have the property of being resistant to corrosion and salt of the sea, to UV radiation, to ozone and to sea water. After the mattress of silicon dioxide gel 10 is rolled up on the composite hose 11, it is possible to cover the same hose by films of polyamide and polyester. Then, with reference to FIG. 3, the outer side of the flexible hose 11 is further covered by a rope made of nylon 12; said rope is rolled up all around the outer side of the hose 11 and all along its longitudinal axis. The result is to achieve a stronger and compact structure of the composite hose 11 and, at the same time, to keep the longitudinal flexibility.

In FIG. 4 it is shown the result of the combination of a composite flexible hose 11 with the insulating mattress made of silicon dioxide gel 10 and the rope made of nylon 12. The result is a compact hose 13, which is very flexible and light, which is characterized by an effective thermal insulation that avoids the creation of ice due to the process of gas liquefaction, necessary to permit its easy transportation, but involving temperatures in the order of −162° C.

As an alternative embodiment of the present invention, the mattress made of silicon dioxide gel 10 can be used not only for insulation of hoses in respect of low temperatures in the inner liquid gas, but also for insulation of hoses in respect of high environmental temperatures. This is the case of the need of protection for flexible hoses, pipelines, and electrical cables, in very hot environments like, in example, in steelworks plants where melted metals and hot heat waves are common.

According to another embodiment, the mattress made of silicon dioxide gel 10 can be installed close to an induction furnace, in particular to a pot furnace, in order to keep a protected space for the winding of electrical wires placed around the pot, and providing at the same time a container for the water necessary for the cooling system.

After description of above examples there is evidence to say that this invention achieves all its goals and, in particular, achieves a composite hose for liquid gas transfer, with liquid gas having a very low temperature, and said hose being covered by a material having a high thermal insulation, like, in example, one or more layers of insulating mattress made of a silicon dioxide gel.

The same invention avoids the creation of ice on the outer side of said hose, and therefore it avoids any possible mechanical breakdown.

Furthermore, the invention achieves a higher level of safety for the operators, because avoiding the creation of ice on the outer side of the hose leads to avoiding the risk of injuries due to the contact of persons with ice.

Also, the composite hose is kept flexible, in order to make possible its transportation to the place of its final installation, and in order to achieve some degree of freedom in view of possible motion of ships during the transfer operations in docks.

Finally, the invention achieves an easy installation of said hose covering, decreasing the use of specialized workers required for its installation.

The present invention has been described for illustrative but not limitative purposes, according to some preferred embodiments; however it is intended that any modifications and/or changes can be introduced by those of ordinary skill in the art without departing from the relevant scope of the invention as defined in the enclosed claims.

I claim:

1. A device for liquid gas transfer comprising:
a flexible composite hose adapted for transporting liquefied natural gas, the hose having an outside surface;
one or more layers of insulation covering the outside surface of the hose;
at least one of the one or more layers of insulation comprising a silicon dioxide gel, whereby the hose is protected from water vapor, and whereby ice formation on the outside of the device is minimized.

2. The device of claim 1, wherein substantially all of the outside surface is covered by the one or more layers of insulation.

3. The device of claim 1, wherein the at least one of the one or more layers of insulation consists essentially of the silicon dioxide gel.

4. The device of claim 1, wherein the one or more layers of insulation covering the outside surface of the hose is applied to the hose by rolling it substantially all around the outside surface of the house and along substantially an entire length of the hose, whereby the creation of ice on the device is minimized.

5. The device of claim 4, wherein the application of the one or more layers of insulation to the hose does not substantially reduce the flexibility of the hose, whereby the device is capable of shifting without breaking during transportation.

6. The device of claim 1, wherein the hose is further covered by one or more nylon ropes.

7. The device of claim 6, wherein the one or more nylon ropes is applied to the hose by rolling it substantially all around the outside surface of the house and along substantially an entire length of the hose.

8. The device of claim 1, wherein the at least one or more layers comprising silicon dioxide gel provides insulation of the hose with respect to high environmental temperatures whereby the hose is not damaged by the high temperatures.

9. A Composite hose for liquid gas transfer, covered by a material having a high thermal insulation, the device comprising:
a flexible composite hose for liquid gas transfer, preferably Compotec® Cryotec 660, having the property of being resistant to corrosion and salt of the sea, to UV radiation, to ozone and to sea water, said hose being covered by an insulation layer;
one or more layers of insulating mattress made of a silicon dioxide gel, preferably Cryogel™ Z, achieving an integrated wall to vapor, in order to give the best thermal protection with the lowest weight and thickness, with completely no passage of water vapor, to be applied to said composite hose,
so that a compact hose can be obtained, being very flexible and light, in order to provide an efficient thermal insulation during the process of liquid gas transfer, in particular avoiding the creation of ice on the outer side of the same composite tube.

10. A Composite hose for liquid gas transfer according to claim 9, wherein:
said one or more layers of insulating mattress made of a silicon dioxide gel are rolled up all along the longitudinal length of said composite hose,
so that the creation of ice is avoided on the outer side of said composite hose, therefore the risk of injuries is avoided to persons that could enter in contact with ice.

11. A Composite hose for liquid gas transfer according to claim 10, wherein:
after the application of said one or more layers of insulating mattress to said composite hose, the same composite hose is kept flexible,
such that it is possible for the hose to be transported to the place of its final installation, and in order to achieve some degree of freedom in view of possible motion of ships during the transfer operations in docks.

12. A Composite hose for liquid gas transfer according to claim 11, wherein:
said flexible hose is further covered by a rope made of nylon, said rope being rolled up all around the outer side of the hose and all along its longitudinal axis,
so that a stronger and compact structure of the composite hose is achieved and at the same time the hose maintains its longitudinal flexibility.

13. A Composite hose for liquid gas transfer according to claim 9, wherein:
said mattress made of silicon dioxide gel provides insulation of said hose with respect to high environmental temperatures,
so that the mattress provides protection of flexible hoses, pipelines, and electrical cables, in very hot environments like, in example, in steelworks plants where melted metals and hot heat waves are common.

14. A Composite hose for liquid gas transfer, according to claim 9, wherein:
the mattress made of silicon dioxide gel is installed close to an induction furnace, in particular to a pot furnace,
so that the mattress provides a protected space for the winding of electrical wires placed around the pot, and , provides at the same time a container for the water necessary for the cooling system.
